(19) United States
(12) Patent Application Publication
(10) Pub. No.: US 2018/0264513 A1
(43) Pub. Date: Sep. 20, 2018

(54) LIQUID DISCHARGE HEAD

(71) Applicant: KABUSHIKI KAISHA TOSHIBA, Minato-ku (JP)

(72) Inventors: Takashi TOGASAKI, Yokohama (JP); Kumiko IOKA, Ichikawa (JP); Takahiro AIZAWA, Yokohama (JP); Michinobu INOUE, Yokohama (JP)

(73) Assignee: KABUSHIKI KAISHA TOSHIBA, Minato-ku (JP)

(21) Appl. No.: 15/917,974

(22) Filed: Mar. 12, 2018

(30) Foreign Application Priority Data
Mar. 17, 2017 (JP) 2017 -053445

(51) Int. Cl. B05C 21/00; B05C 5/02; B41J 2/14; B41J 2/045

(52) U.S. Cl. CPC B05C 21/00; B05C 5/0279; B41J 2/04581; B41J 2/04541; B41J 2/14201

(57) ABSTRACT

In one embodiment, a liquid discharge head includes, a circuit board including a drive IC, and a circulation flow path including a supply flow path that communicates with a liquid discharge unit that discharges liquid, and a collection flow path that is provided in a manner so that heat is transmittable to the circuit board, the collection flow path that communicates with the liquid discharge unit.

### CROSS-REFERENCE TO RELATED APPLICATIONS

This application is based upon and claims the benefit of priority from the prior Japanese Patent Application No. 2017-053445, filed Mar. 17, 2017 the entire contents of which are incorporated herein by reference.

### FIELD

Embodiments described herein relate generally to a liquid discharge head.

### BACKGROUND

A liquid discharge device is used in the manufacture of various types of printed matter and various display devices such as a liquid crystal display, an electron emission display device, a plasma display device, an electrophoresis display device, etc. A liquid discharge device includes a liquid discharge head that ejects droplets from a plurality of nozzles, respectively, to a coating target, for example. The liquid discharge head includes: a nozzle plate having the nozzles; a piezoelectric base having a plurality of piezoelectric elements and pressure chambers that communicate with the nozzles; and drive ICs that apply driving voltages to the piezoelectric elements. A well-known configuration for a liquid discharge head and a liquid discharge device is a circulation type that circulates a coating liquid such as ink to remove any bubbles or foreign objects.

These kinds of liquid discharge heads and liquid discharge devices require a technique to suppress the temperature increase caused by heat generated by heating components such as a circuit board, a drive IC, etc.

### BRIEF DESCRIPTION OF THE DRAWINGS

FIG. 1 is an illustration diagram illustrating a liquid discharge head according to a first embodiment;

FIG. 2 is an illustration diagram illustrating a part of head modules of liquid discharge heads according to the first embodiment and a second embodiment;

FIG. 3 is an illustration diagram illustrating the heat radiating performance of the liquid discharge heads according to the first embodiment and a third embodiment;

FIG. 4 is a front view of the liquid discharge head according to the second embodiment;

FIG. 5 is a cross-sectional view of the aforementioned liquid discharge head;

FIG. 6 is a front view of a head module of the aforementioned liquid discharge head;

FIG. 7 is an illustration diagram illustrating the aforementioned head module by partially showing a cross section;

FIG. 8 is an illustration diagram illustrating the liquid discharge head according to the third embodiment;

FIG. 9 is a front view of a liquid discharge head according to a fourth embodiment; and

FIG. 10 is a cross-sectional view of a liquid discharge head according to a fifth embodiment.

### DETAILED DESCRIPTION

In one embodiment, a liquid discharge head comprises, a circuit board including a drive IC, and a circulation flow path including a supply flow path that communicates with a liquid discharge unit that discharges liquid, and a collection flow path that is provided in a manner so that heat is transmittable to the circuit board, the collection flow path that communicates with the liquid discharge unit.

### First Embodiment

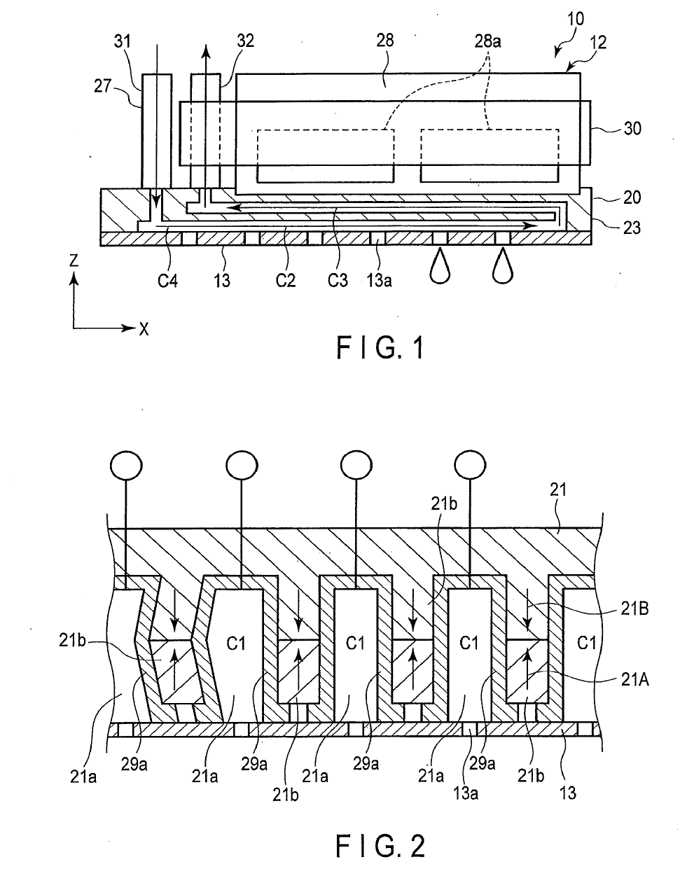

Hereinafter, the configuration of a liquid discharge head 10 according to the first embodiment will be explained with reference to FIGS. 1 and 2. In the drawings, arrows X, Y, and Z indicate three directions, a first direction, a second direction, and a third direction which are perpendicular to each other. In each of the drawings, the configuration is partially enlarged, reduced, or omitted as appropriate for the sake of explanation. FIG. 1 is an illustration diagram illustrating the liquid discharge head 10. FIG. 2 is a cross-sectional view showing a part of a head module 12.

The liquid discharge head 10 shown in FIGS. 1 and 2 is a so-called share mode share wall type. The liquid discharge head 10 includes: a housing 11; the head module 12 contained in the housing 11; and a nozzle plate 13 having a plurality of nozzles 13a as liquid discharge units. The liquid discharge head 10 is a head of a circulation type that is connected to an ink tank as a liquid container and circulates ink between the liquid discharge head 10 and the ink tank.

As shown in FIGS. 1 and 2, the head module 12 includes: an actuator unit 20 having a piezoelectric base 21 and a cover plate 23; a pipe unit 27; and a circuit board 28 having drive ICs 28a mounted thereon.

As shown in FIG. 2, the piezoelectric base 21 includes a piezoelectric laminate formed by laminating a first piezoelectric member 21A and a second piezoelectric member 21B. The first piezoelectric member 21A and the second piezoelectric member 21B are polarized in a manner so that their polarization directions are reversed to each other. The first piezoelectric member 21A and the second piezoelectric member 21B are bonded to each other with an adhesive layer interposed therebetween. As the first piezoelectric member 21A and the second piezoelectric member 21B, for example, PZT (Lead Zirconate Titanate) is used.

A plurality of grooves 21a that form pressure chambers C1 are provided in parallel in the side face of the piezoelectric base 21, which faces the nozzle plate 13. The grooves 21a are opened into the nozzle plate 13 side. The pressure chambers C1 formed of the grooves 21a have inner walls provided with electrodes 29a, respectively.

Columnar shaped parts each remaining between the plurality of grooves 21a form piezoelectric elements 21b. The piezoelectric elements 21b serve as a plurality of electrostatic capacitance loads that apply an ink-introduction pressure and an ink-ejection pressure into the pressure chambers 01. The proximal portions of the respective piezoelectric elements 21b are continuous in a manner so that the piezoelectric base 21 has the comb-shaped cross section.

As shown in FIG. 1, the circuit board 28 is disposed on the other side of the piezoelectric base 21, which is opposite to the nozzle plate 13. The electrodes 29a are connected to a wiring pattern on the circuit board 28. That is, the piezoelectric elements 21b are electrically connected to the circuit board 28.

The cover plate 23 is disposed on one of two faces of the piezoelectric base 21 in a manner so that the cover plate 23 and the piezoelectric base 21 face each other. The cover plate 23 is provided with grooves that form a supply chamber C2 and a collection chamber C3, each of which forms a flow path that communicates with the grooves 21a.

The pipe unit 27 is disposed on the end in the first direction of the circuit board 28. The pipe unit 27 includes a supply tube 31 that forms a supply flow path, and a collection tube that forms a collection flow path. The supply tube 31 and the collection tube 32 are thermally insulated from each other. Specifically, the supply tube 31 and the collection tube 32 are arranged in parallel with a space interposed therebetween. The supply tube 31 has its lower end connected to the supply chamber C2, while the collection tube 32 has its lower end connected to the collection chamber C3.

The collection tube 32 is disposed between the supply tube 31 and the circuit board 28 in a manner so that heat is transmittable to the side of the circuit board 28 on which the drive ICs 28a are mounted. Specifically, the collection tube 32 is disposed closer to the circuit board 28 than the supply tube 31. The collection tube 32 and the circuit board 28 are bonded to the heat transfer sheet 30 as a heat transfer member. The heat transfer sheet 30 is a sheet-shaped member made from a heat transfer material with high heat conductivity. For example, the heat transfer sheet 30 is formed in a manner to have the heat conductivity of 200 W/mK or higher. The heat transfer sheet 30 is not bonded to the supply tube 31.

The supply tube 31 is disposed on the outer side of the collection tube 32, at a position distant from the circuit board 28. The supply tube 31 and the collection tube 32 are disposed separately from each other in a manner so that a space is interposed between them.

The circuit board 28 is connected to the side of the piezoelectric base 21, which is opposite to the nozzle plate 13, and is fixed to a holding plate. The circuit board 28 includes the drive ICs 28a for driving the liquid discharge head 10. The drive ICs 28a of the circuit board 28 are connected to the electrodes 29a within the pressure chambers C1, respectively, through a wiring pattern.

Under the ejection instructions from a controller, the drive ICs 28a apply a predetermined voltage to the electrodes 29a connected to the piezoelectric elements 21b on both sides of each of the pressure chambers C1.

The liquid discharge head 10 configured as described above contains therein a circulation flow path C4 that includes a supply-side flow path and a collection-side flow path. The supply-side flow path extends from an exterior ink tank 15 through a supply coupling tube 33, the supply tube 31, and the supply chamber C2 to each of the pressure chambers C1. The collection-side flow path extends from each of the pressure chambers C1 through the collection chamber C3 and the collection tube 32 to the exterior ink tank 15. That is, the supply tube 31, the collection tube 32, the supply chamber C2, the pressure chambers C1, and the collection chamber C3 form the circulation flow path C4.

The nozzle plate 13 has a square shape with a predetermined thickness, and is disposed in a manner so that the nozzle plate 13 and the piezoelectric base 21 face each other, and the side face of the piezoelectric base 21, on which the plurality of grooves 21a are formed, is covered with the nozzle plate 13. The nozzle plate 13 is provided with a nozzle array including the plurality of nozzles 13a that penetrate the nozzle plate 13 in the thickness direction along the third direction. The nozzles 13a are disposed in positions corresponding to the pressure chambers C1, respectively.

The liquid discharge head 10 applies a driving pressure to the piezoelectric elements 21b as driving elements via a wiring pattern and the electrodes 29a by means of the drive ICs 28a. This application of a driving pressure gives a potential difference between the electrode 29a within the driving pressure chamber C1, and the adjacent electrodes 29a. When such a potential difference is given, a first piezoelectric member and a second piezoelectric member are deformed in mutually-reversed directions, thereby causing a bending deformation in the piezoelectric element 21b, as shown in FIG. 2. The bending deformation described above is alternatively repeated so that droplets are discharged from the nozzles 13a in a continuous manner.

The liquid discharge head 10 is provided in, for example, a liquid discharge device including a plurality of liquid discharge heads 10, a supporting mechanism, and a controller. The liquid discharge heads 10 discharge droplets. The supporting mechanism supports the liquid discharge heads 10 and an ejection target in a manner movable relative to each other. The controller controls operations of respective units including the liquid discharge heads 10 and the supporting mechanism.

In order for the liquid discharge device to perform printing by discharging a coating material (ejection material) as liquid from the nozzles 13a, upon detection of the input of an instruction to start printing, the controller controls operations of the liquid discharge head 10, a head moving mechanism, and a target moving mechanism to perform a droplet ejection operation in accordance with various programs.

The liquid discharge head 10 according to the present embodiment achieves the improved heat radiating performance by bringing the collection tube 32 that forms the collection flow path, close to the circuit board 28 including the drive ICs 28a functioning as heating components. That is, when ink supplied from the ink tank passes through the collection flow path, this ink passes near the drive ICs 28a as a heat source and absorbs heat therefrom, thereby being able to radiate heat to the outside.

Furthermore, bonding to the heat transfer sheet 30 with high heat conductivity enables the liquid discharge head 10 to enhance effective heat radiation.

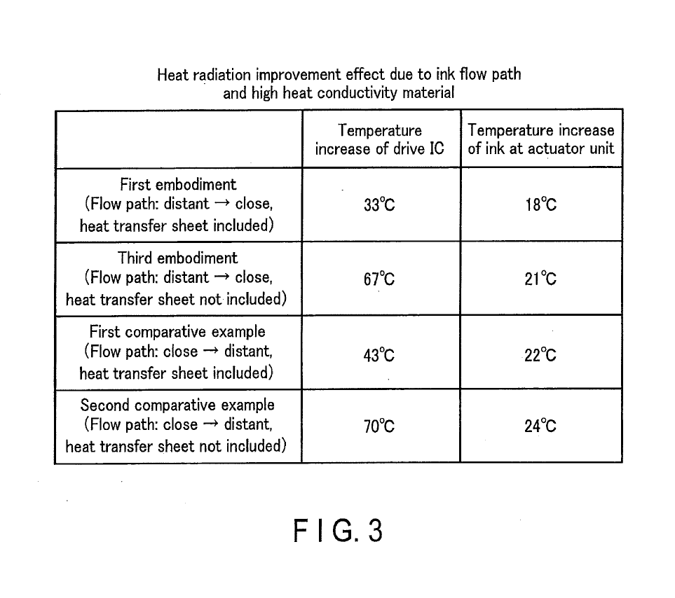

FIG. 3 is an illustration diagram illustrating the heat radiating performance of the liquid discharge head 10 according to the present embodiment and liquid discharge heads 10A according to various comparative examples and other embodiments. A first comparative example is an example in which a supply-side direction and a collection-side direction of the liquid discharge head 10 are reversed to each other. FIG. 3 shows the increase in temperature of the drive ICs 28a and the increase in temperature of ink in the actuator unit 20 at the center part of the liquid discharge head, in which the temperature reaches a peak. In the first comparative example, a circuit board and a supply tube, not a collection tube, are bonded to each other by a graphite sheet as a heat transfer sheet. A second comparative example is configured in a manner so that a supply-side direction and a collection-side direction of the liquid discharge head 10 are reversed to each other, and that the heat transfer sheet is omitted.

In the liquid discharge head 10, the collection-side is brought close to the circuit board 28 and bonding is made with the heat transfer sheet 30. As shown in FIG. 3, this liquid discharge head 10 suppresses the increase in temperature and improves the heat radiating performance, as compared to the first comparative example in which a flow-path direction is reversed and the collection-side is separated from the circuit board, and the second comparative example in which the heat transfer sheet is not used. Specifically, it is understood that the configuration in which the ink flow path has its discharge-side closer to the circuit board than its supply-side brings about a 30% improvement in the heat radiating performance (1/temperature increase) of the drive ICs, and a 15% improvement in the heat radiating performance (1/temperature increase) of the actuator unit.

### Second Embodiment

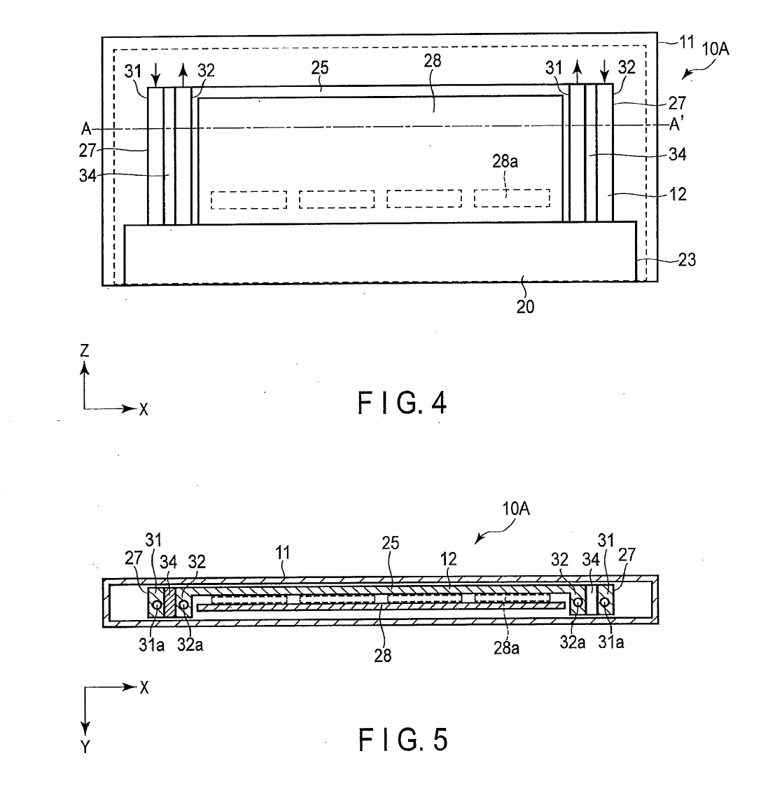

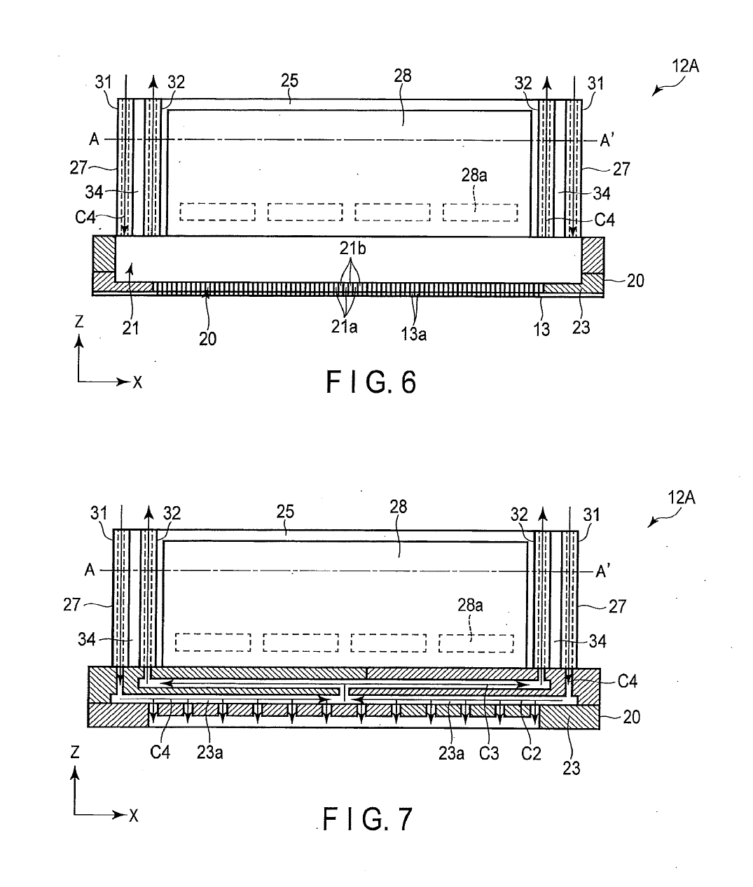

Hereinafter, the configuration of a liquid discharge head 10A according to the second embodiment will be explained with reference to FIGS. 2 and 4 to 7. In the drawings, arrows X, Y, and Z indicate three directions which are perpendicular to each other. In each of the drawings, the configuration is partially enlarged, reduced, or omitted as appropriate for the sake of explanation. FIG. 4 is a front view showing the configuration of the liquid discharge head 10A according to the second embodiment. FIG. 5 is a cross-sectional view showing the configuration of the liquid discharge head 10A. Each of FIGS. 6 and 7 is a front view showing the configuration of a head module 12A of the liquid discharge head 10A.

The liquid discharge head 10A shown in each of FIGS. 4 to 7 is a so-called share mode share wall type. The liquid discharge head 10A includes the housing 11, the head module 12A contained in the housing 11, and the nozzle plate 13 having the plurality of nozzles 13a. The liquid discharge head 10 is a head of a circulation type that is connected to an ink tank as a liquid container and circulates ink between the liquid discharge head 10 and the ink tank.

As shown in FIGS. 4 to 7, the head module 12A includes: the actuator unit 20 having the piezoelectric base 21 and the cover plate 23; a holding plate 25; the pipe units 27 formed in both ends of the holding plate 25; and the circuit board 28 having the drive ICs 28a mounted thereon.

As shown in FIG. 5, the piezoelectric base 21 includes the piezoelectric laminate formed by laminating the first piezoelectric member 21A and the second piezoelectric member 21B. The first piezoelectric member 21A and the second piezoelectric member 21B are polarized in a manner so that their polarization directions are reversed to each other. The first piezoelectric member 21A and the second piezoelectric member 21B are bonded to each other with an adhesive layer interposed therebetween. As the first piezoelectric member 21A and the second piezoelectric member 21B, for example, PZT (Lead Zirconate Titanate) is used.

As shown in FIGS. 2 and 6, the plurality of grooves 21a that form pressure chambers C1 are provided in parallel in the side face of the piezoelectric base 21, which faces the nozzle plate 13. The grooves 21a are opened into the nozzle plate 13 side. The pressure chambers C1 formed of the grooves 21a have inner walls provided with the electrodes 29a, respectively.

Columnar shaped parts remaining between the plurality of grooves 21a form the piezoelectric elements 21b. The piezoelectric elements 21b serve as a plurality of electrostatic capacitance loads that apply an ink-introduction pressure and an ink-ejection pressure into the pressure chambers C1. The proximal portions of the respective piezoelectric elements 21b are continuous in a manner so that the piezoelectric base 21 has the comb-shaped cross section.

The circuit board 28 is mounted on the other side of the piezoelectric base 21, which is opposite to the nozzle plate 13. The electrodes 29a are connected to a wiring pattern on the circuit board 28. That is, the piezoelectric elements 21b are electrically connected to the circuit board 28.

The cover plate 23 is disposed on the piezoelectric base 21 in a manner to face each other. The cover plate 23 is provided with a flow path that communicates with the grooves 21a of the piezoelectric base 21. Specifically, the cover plate 23 is provided with grooves 23a that form a supply chamber C2 and a collection chamber C3, each of which communicates with the plurality of pressure chambers C1. In the present embodiment, the single liquid discharge head 10A is provided with the flow path of two systems. Thus, the cover plate 23 is provided with two systems of the grooves 23a that guide liquid from both ends to the center in a manner so that the supply chamber C2 and the collection chamber C3 are formed in pairs.

The holding plate 25 is formed in a rectangular plate shape. The circuit board 28 is disposed on the main face of two faces of the holding plate 25 in a manner so that the circuit board 28 and the holding plate 25 face each other. The collection tubes 32 of the pipe units 27 are integrally provided in both ends in the first direction along the X axis of the holding plate 25.

The pipe units 27 include the supply tubes 31 and the collection tubes 32, respectively. Each of the supply tubes 31 forms a supply flow path 31a. Each of the collection tubes 32 forms a collection flow path 32a. The supply tubes 31 and the collection tubes 32 are disposed on both ends in the first direction of the circuit board 28, respectively, and extend in the third direction along the Z axis. In the present embodiment, the collection tubes 32 are integrally formed as a part of the holding plate 25, at both ends of the holding plate 25. The supply tubes 31 are provided on the outer side in the first direction of the collection tubes 32, with heat insulating units 34 interposed between the supply tubes 31 and the collection tubes 32, respectively. The heat insulating units 34 suppress heat transfer.

The supply tubes 31 and the collection tubes 32 are arranged in parallel with the heat insulating units 34 interposed therebetween, respectively. The supply tubes 31 and the collection tubes 32 are connected to the supply chambers C2 and the collection chambers C3 of the actuator unit 20, respectively.

Each of the heat insulating units 34 is formed of, for example, a gap or a heat insulating member. The heat insulating member forming the heat insulating units 34 is, for example, a resin-made member in a plate shape, which is made from a material with the heat conductivity of 1.0 W/mK or lower.

Each of the collection tubes 32 is disposed between each of the supply, tubes 31 and the circuit board 28 in a manner so that heat is transmittable to the side of the circuit board 28 on which the drive ICs 28a are mounted. Specifically, the collection tubes 32 are integrally provided in a continuous manner in both ends of the holding plate 25. Each of the collection tubes 32 is a tube member that has a square-pillar outer shape and a cross section with a circular hole. The collection tubes 32 are disposed closer to the circuit board 28 than the supply tubes 31.

The supply tubes 31 are disposed on the outer side of the collection tubes 32, at positions distant from the circuit board 28. Each of the supply tubes 31 is formed of a tube member that has a square-pillar outer shape and a cross section with a circular hole. The supply tubes 31 and the collection tubes 32 are disposed separately in a manner so that spaces or the heat insulating units 34 are interposed between the supply tubes 31 and the collection tubes 32, respectively.

The circuit board 28 is connected to the side of the piezoelectric base 21, which is opposite to the nozzle plate 13, and is fixed to the holding plate 25. The circuit board 28 includes the drive ICs 28a for driving the liquid discharge head 10A. The drive ICs 28a of the circuit board 28 are connected to the electrodes 29a within the pressure chambers C1, respectively, through a wiring pattern. The circuit board 28 is disposed on the main face of the holding plate 25 in a manner to face each other. The drive ICs 28a are mounted on the circuit board 28 at its face on the holding plate 25 side. The drive ICs 28a are disposed in contact with the main face of the holding plate 25.

Under the ejection instructions from a controller, the drive ICs 28a apply a predetermined voltage to the electrodes 29a connected to the piezoelectric elements 21b on both sides of each of the pressure chambers C1.

The liquid discharge head 10A configured as described above contains therein the circulation flow path C4 that includes a supply-side flow path and a collection-side flow path. The supply-side flow path extends from an exterior ink tank through the supply tubes 31 and the supply chambers C2 to the respective pressure chambers C1. The collection-side flow path extends from the respective pressure chambers C1 through the collection chambers C3 and the collection tubes 32 to the exterior ink tank.

Each head module 12A according to the present embodiment is provided with the circulation flow path C4 of two systems including the pair of pipe units 27, the pair of supply chambers C2, and the pair of collection chambers C3.

The nozzle plate 13 has a square shape with a predetermined thickness, and is disposed in a manner so that the side face of the actuator unit 20, on which the plurality of grooves 21a are formed, is covered with the nozzle plate 13, and the nozzle plate 13 and the actuator unit 20 face each other. The nozzle plate 13 is provided with a nozzle array including the plurality of nozzles 13a that penetrate the nozzle plate 13 in the thickness direction along the third direction. The nozzles 13a are disposed in positions corresponding to the pressure chambers C1, respectively.

The liquid discharge head 10A applies a driving pressure to the piezoelectric elements 21b as driving elements via the electrodes 29a by means of the drive ICs 28a. This application of a driving pressure gives a potential difference between the electrode 29a within the driving pressure chamber C1, and the adjacent electrodes 29a. When such a potential difference is given, a first piezoelectric member and a second piezoelectric member are deformed in mutually-reversed directions, thereby causing a bending deformation in the piezoelectric element 21b, as shown in FIG. 2. The bending deformation described above is alternatively repeated so that droplets are discharged from the nozzles 13a in a continuous manner.

The liquid discharge head 10A is provided in, for example, a liquid discharge device including a plurality of liquid discharge heads 10A, a supporting mechanism, and a controller. The liquid discharge heads 10A discharge droplets. The supporting mechanism supports the liquid discharge heads 10A and an ejection target in a manner movable relative to each other. The controller controls operations of respective units including a liquid discharge head 10B and the supporting mechanism.

In order for the liquid discharge device to perform printing by discharging a coating material (ejection material) as liquid from the nozzles 13a, upon detection of the input of instruction to start printing, the controller controls operations of the liquid discharge head 10A, a head moving mechanism, and a target moving mechanism to perform a droplet ejection operation in accordance with various programs.

Other than the above, the liquid discharge head 10A is configured in a manner similar to the liquid discharge head 10 according to the first embodiment.

The liquid discharge head 10A according to the present embodiment achieves improved heat radiating performance by bringing the collection flow path, close to the circuit board 28 including the drive ICs 28afunctioning as heating components, in a manner similar to the liquid discharge head 10 according to the first embodiment. That is, when ink supplied from the ink tank passes through the collection flow path, this ink passes near the drive ICs 28a as a heat source and absorbs heat therefrom, thereby being able to radiate heat to the outside.

In addition, the configuration of the collection tubes 32 integral with the holding plate 25 enables easy manufacturing and facilitates transfer of heat from heating components through the holding plate 25 to the collection tubes 32. Thus, the high heat radiating performance can be ensured.

### Third Embodiment

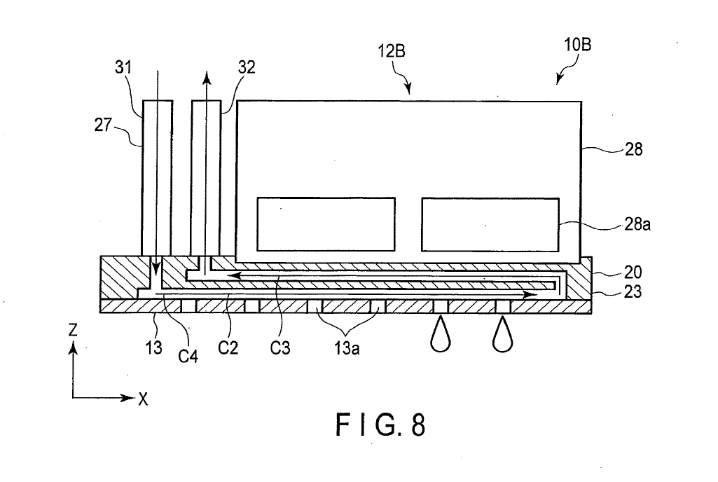

The present invention is not limited to the foregoing embodiments. The above embodiments have assumed an example where the heat transfer sheet 30 is included, but this is not a limitation. For example, as the third embodiment, the heat transfer sheet 30 may not be included, as in the liquid discharge head 10B shown in FIG. 8. Other than the above, the liquid discharge head 10B is configured in a manner similar to the liquid discharge heads 10 and 10A according to the above embodiments. The third embodiment is also configured in a manner so that heat transfer from the circuit board 28 and drive ICs 28a as heating components to the collection tube 32 is made easier than such heat transfer to the supply tube 31. With such a configuration, heat can be radiated through ink flowing from liquid discharge units while suppressing the increase in temperature of ink flowing in the liquid discharge units. Thus, this embodiment can also achieve the high heat radiating performance.

### Fourth Embodiment

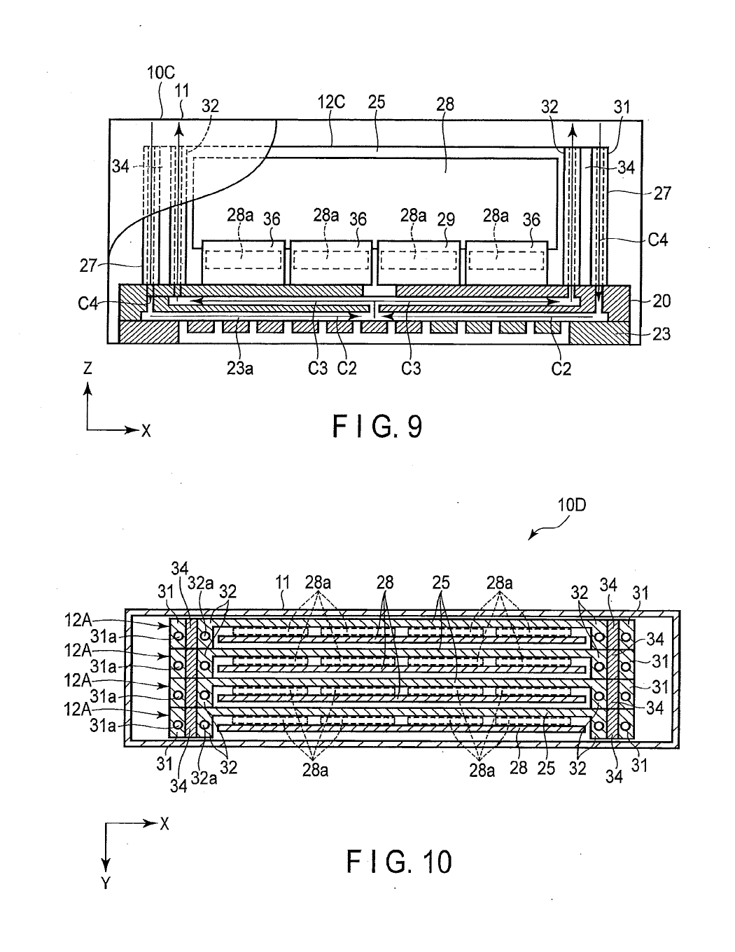

The above embodiments have assumed an example where the drive ICs 28a are mounted on the circuit board 28, but this is not a limitation. FIG. 9 is a front view showing the configuration of a liquid discharge head 10C according to the fourth embodiment. In FIG. 9, for the sake of explanation, the housing 11 is partially cut out to show the inner configuration. For example, as the fourth embodiment, the drive ICs may be connected to the circuit board 28 through flexible wiring boards 36, as in the liquid discharge head 10C shown in FIG. 9. In the liquid discharge head 10C, the end edge of the circuit board 28, on the actuator unit 20 side, is separated from the actuator unit 20. The plurality of flexible wiring boards 36 having the drive ICs 28a mounted thereon are connected to the circuit board 28. Namely, the circuit board 28 and the actuator unit 20 are connected to each other through the plurality of flexible wiring boards 36 including the drive ICs 28. Other than the above, the liquid discharge head 10C is configured in a manner similar to the liquid discharge heads 10, 10A, 10B, etc. according the above embodiments. The liquid discharge head 10C according to the present embodiment is configured in a manner so that heat transfer from the circuit board 28 and drive ICs 28a as heating components to the collection tube 32 is made easier than such heat transfer to the supply tube 31. With such a configuration, the high heat radiating performance can be secured while suppressing the increase in temperature of ink on the inflow side, in a manner similar to the liquid discharge heads 10, 10A, and 10B described above.

### Fifth Embodiment

The above embodiments have assumed an example where the single head module, the head module 12 or 12A, is disposed within the housing 11, but this is not a limitation. A plurality of head modules may be laminated and disposed. For example, a liquid discharge head 10D shown as the fifth embodiment in FIG. 10 has a laminated structure in which a plurality of head modules 12A are laminated in the second direction along the Y axis within the housing 11. Other than the above, the plurality of head modules 12A are configured in a manner similar to the head module 12A of the liquid discharge head 10A according to the second embodiment, etc. The liquid discharge head 10D according to the present embodiment is also configured in a manner so that heat transfer from the circuit board 28 and drive ICs 28a as heating components to the collection tube 32 is made easier than such heat transfer to the supply tube 31. The liquid discharge head 10D with such a configuration can realize both the high heat radiating performance and the reduction in ink temperature, thereby being able to achieve advantageous effects similar to those achieved by the liquid discharge heads 10, 10A, 10B, and 10C.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A liquid discharge head comprising:
a circuit board including a drive IC; and
a circulation flow path including:
a supply flow path that communicates with a liquid discharge unit that discharges liquid; and
a collection flow path that is provided in a manner so that heat is transmittable to the circuit board, the collection flow path that communicates with the liquid discharge unit.

2. A liquid discharge head comprising:
a circuit board;
a piezoelectric base including:
a plurality of piezoelectric elements that are electrically connected to the circuit board; and
a plurality of pressure chambers that communicate with nozzles configured to discharges liquid; and
a pipe unit including:
a supply tube including a supply flow path that communicates with the pressure chambers and allows liquid to flow, the liquid to be supplied to the pressure chambers; and
a collection tube including a collection flow path that is disposed closer to the circuit board than the supply tube, communicates with the pressure chambers, and allows liquid to flow, the liquid to be collected from the pressure chambers.

3. The liquid discharge head according to claim 2, wherein the collection tube is connected in a manner so that heat is transmittable through a heat transfer member having heat conductivity of 200 W/mK or higher to the circuit board or a drive IC mounted on the circuit board.

4. The liquid discharge head according to claim 2, wherein the supply tube and the collection tube are disposed separately from each other with a space interposed between the supply tube and the collection tube.

5. The liquid discharge head according to claim 2, wherein the supply tube and the collection tube are disposed with a heat insulating unit having heat conductivity of 1.0 W/mK or lower interposed between the supply tube and the collection tube.
